(19) United States
(12) Patent Application Publication
(10) Pub. No.: US 2008/0019562 A1
(43) Pub. Date: Jan. 24, 2008

(54) Image Forming Apparatus

(75) Inventors: Shinji MAKISHIMA, Tokyo (JP); Kazuhiro Ogura, Fujisawa-shi (JP); Akihiro Mizutani, Tokyo (JP); Toshihiro Ida, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Tokyo (JP)

(21) Appl. No.: 11/456,559

(22) Filed: Jul. 10, 2006

(51) Int. Cl. G06K 9/00

(52) U.S. Cl. 382/101

(57) ABSTRACT

An image forming apparatus acquires, after acquiring a user ID of a user, an input of a criteria button for instructing creation of electronic data of an image quality satisfying predetermined criteria. The apparatus acquires electronic data and checks whether an image quality of the electronic data acquired satisfies the predetermined criteria. The apparatus transmits, on the basis of the image quality of the electronic data checked, a mail to a mail address of the user on a network corresponding to the user ID.

### BACKGROUND OF THE INVENTION

1. Field of the Invention

The present invention relates to an image forming apparatus that creates electronic data from a paper document.

2. Description of the Related Art

There is known a technique for adding, in transmitting a scanned image file to a specific mail address by mail (scan to mail), a mail address of a person who scanned the image file to a sender of the mail to transmit an error message for the mail and a reply from a receiver to a computer of the person who scanned the mail.

Paper documents managed in companies and the like tend to be stored in an electronic form and managed. When the paper documents are managed as electronic data in this way, in general, the paper documents are scanned by a scanner and electronic data indicating an image created is stored. In this case, it is necessary to guarantee readability, integrity, and the like of the image indicated by the electronic data. Thus, it is necessary to perform designation of resolution, visual confirmation of content of the image, and the like to guarantee readability. Further, it is necessary to apply a digital signature and a time stamp to guarantee integrity.

In the conventional technique, it is possible to read the mail address of the person who scanned the image indicated by the electronic data. However, this does not mean that it is possible to check an image quality of the electronic data indicating whether the image indicated by the electronic data satisfies predetermined criteria for guaranteeing, for example, readability and integrity.

### BRIEF SUMMARY OF THE INVENTION

It is an object of the invention to provide an image forming apparatus that stores electronic data of a paper document satisfying predetermined criteria.

According to an aspect of the invention, an image forming apparatus includes: a user ID acquiring unit configured to acquire a user ID for identifying a user; a criteria button input acquiring unit configured to acquire an input of a criteria button for instructing creation of electronic data of an image quality satisfying predetermined criteria; a user information acquiring unit configured to acquire user information indicating a mail address of the user on a network corresponding to the user ID acquired by the user ID acquiring unit; an electronic data acquiring unit configured to acquire electronic data indicating an image; an image quality checking unit configured to check, when an input of the criteria button is acquired by the criteria button input acquiring unit, whether an image quality of the electronic data acquired by the electronic data acquiring unit satisfies the predetermined criteria; and a mail transmitting unit configured to transmit, on the basis of the image quality of the electronic data checked by the image quality checking unit, a mail to a mail address specified by the user information acquired by the user information acquiring unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF SEVERAL VIEWS OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram schematically showing a network structure in a first embodiment of the invention;

FIG. 2 is a block diagram showing a main structure of an image forming apparatus in the embodiment;

FIG. 3 is a block diagram showing functions of the image forming apparatus in the embodiment;

FIG. 4 is a flowchart showing a main part of image quality check processing in the embodiment;

FIG. 5 is a diagram showing an example of a success mail in the embodiment;

FIG. 6 is a diagram showing an example of a warning mail in the embodiment;

FIG. 7 is a block diagram showing functions of an image forming apparatus in a second embodiment of the invention; and

FIG. 8 is a flowchart showing a main part of image quality check processing in the embodiment.

### DETAILED DESCRIPTION OF THE INVENTION

Embodiments of the invention will be hereinafter explained with reference to the drawings.

### First Embodiment

First, a first embodiment will be explained.

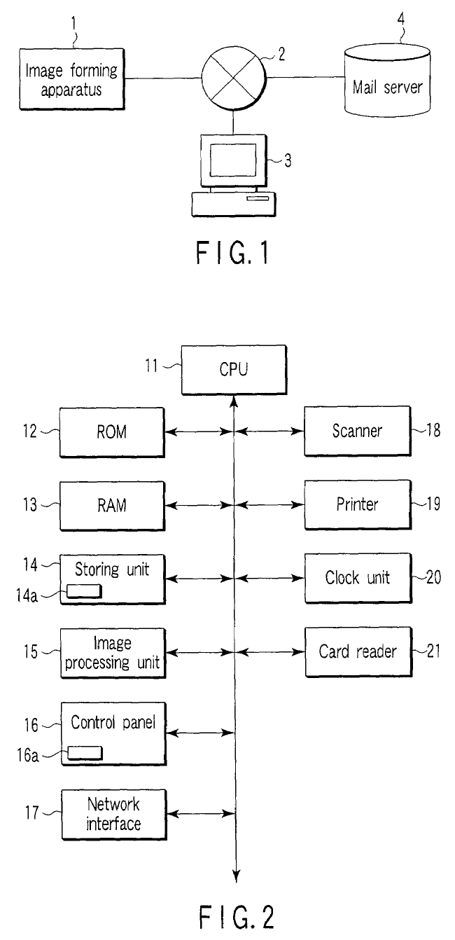

FIG. 1 is a diagram schematically showing a network structure. As shown in FIG. 1, an image forming apparatus 1 is connected to a communication network 2. A personal computer (PC) 3 and a mail server 4 are further connected to this communication network 2. The mail server 4 performs control for transmission and reception of mails among PCs 3, transmission and reception of mails transmitted from the image forming apparatus 1 to the PC 3, and the like via the network 2. Since this control has been conventionally performed, the control will not be explained in detail.

FIG. 2 is a block diagram showing a main structure of the image forming apparatus 1. As shown in FIG. 2, the image forming apparatus 1 includes a CPU 11, a ROM 12, a RAM 13, a storing unit 14, an image processing unit 15, a control panel 16, a network interface 17, a scanner 18, a printer 19, a clock unit 20, and a card reader 21. The CPU 11 and the ROM 12, the RAM 13, the storing unit 14, the image processing unit 15, the control panel 16, the network interface 17, the scanner 18, the printer 19, the clock unit 20, and the card reader 21 are connected via a bus line.

The CPU 11 controls the entire image forming apparatus 1 by executing a control program stored in the ROM 12. The ROM 12 stores the control program executed by the CPU 11 and fixed data. The RAM 13 has a work area and the like required when the CPU 11 executes the control program stored in the ROM 12.

The storing unit 14 is, for example, a hard disk drive. The storing unit 14 stores, for example, an application program such as an image quality check processing control program described later and a user table 14a. The user table 14a is a table in which a user ID, which indicates that a user is registered in the image forming apparatus 1, and a mail address on a network are stored in association with each other.

The image processing unit 15 applies compression, expansion, and the like to image data.

The control panel 16 has an operation unit and a display unit. A criteria button 16a is provided in the operation unit. This criteria button 16a is a button that the user depresses, in scanning a paper document, to cause the scanner 18 to read the paper document with an image quality of predetermined criteria. As the predetermined criteria, there are criteria for applying a digital signature. In applying a digital signature, an image quality is required to satisfy a certain criteria to guarantee readability and integrity. The criteria will be explained in detail in an explanation of the image quality checking unit 35 described later.

The network interface 17 is used for connection with the network 2.

The scanner 18 reads an image from a paper document placed on a not-shown paper document stand or a paper document fed by a riot-shown automatic paper feeder and generates electronic data indicating the image. The image data generated in this way is subjected to compression processing by the image processing unit 15 and stored in the storing unit 14. The electronic data stored in the storing unit 14 in this way is read out from the storing unit 14 and subjected to expansion processing by the image processing unit 15. Then, the electronic data may be outputted to the printer 19 or may be read out by the PC 3 via the network 2. Before the operation for scanning the paper document, since a user ID is authenticated by the card reader 21, the user ID is associated with the electronic data indicating the image.

The printer 19 forms an image on a sheet on the basis of a print job received via the network 2 or the image data read out from the storing unit 14 and subjected to expansion processing by the image processing unit 15.

The clock unit 20 generates date and time information. The date and time information generated by the clock unit 20 is acquired by the CPU 11 as required.

The card reader 21 reads information stored in an IC card. Information indicating a user ID is stored in the IC card. When this user ID is registered in the user table 14a, use of the image forming apparatus 1 is permitted.

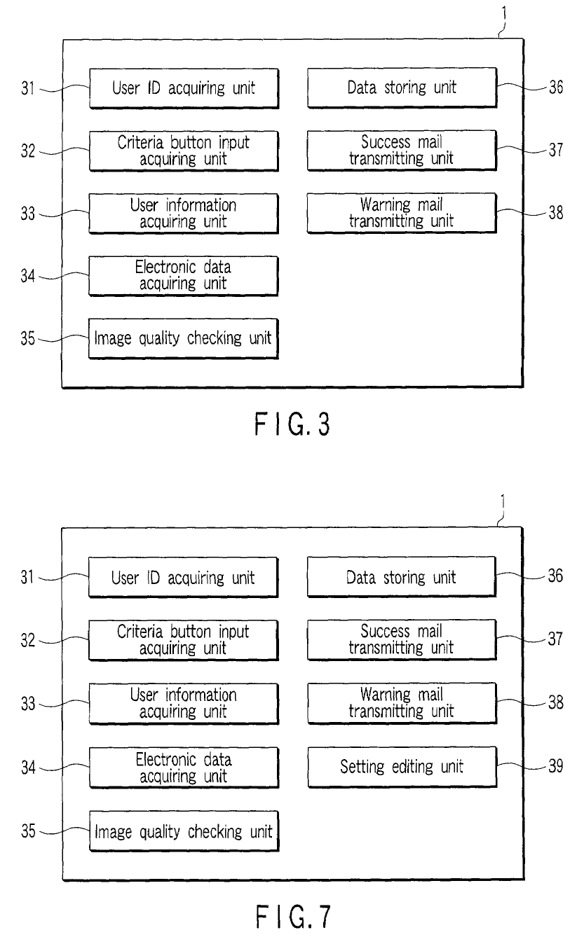

FIG. 3 is a block diagram showing functions of the image forming apparatus 1. The image forming apparatus 1 has a user ID acquiring unit 31, a criteria button input acquiring unit 32, a user information acquiring unit 33, an electronic data acquiring unit 34, an image quality check unit 35, a data storing unit 36, a success mail transmitting unit 37, and a warning mail transmitting unit 38.

The user ID acquiring unit 31 acquires a user ID via the card reader 21. The criteria button input acquiring unit 32 acquires information on whether the criteria button 16a is inputted when a paper document is read by the scanner 18. The user information acquiring unit 33 acquires a mail address corresponding to the user ID acquired by the user ID acquiring unit 31 from the user table 14a. The electronic data acquiring unit 34 acquires electronic data indicating an image of the paper document generated by the scanner 18 from the storing unit 14. The image quality checking unit 35 checks, when the input of the reference button 16a is acquired by the criteria button input acquiring unit 32, whether the electronic data of the image read by the scanner 18 satisfies predetermined criteria. The data storing unit 36 stores the electronic data, which is checked by the image quality checking unit 35 and satisfies the predetermined criteria, in a predetermined area in the storing unit 14. The success mail transmitting unit 37 transmits, when the electronic data satisfying the predetermined criteria is stored in the storing unit 14, a mail in which an indication that the electronic data satisfying the predetermined criteria is created is written to the mail address acquired by the user information acquiring unit 33. The warning mail transmitting unit 38 transmits a mail in which an indication that electronic data satisfying the predetermined criteria is not created is written to the mail address acquired by the user information acquiring unit 33.

The functions realized by the user ID acquiring unit 31, the criteria button input acquiring unit 32, the user information acquiring unit 33, the electronic data acquiring unit 34, the image quality check unit 35, the data storing unit 36, the success mail transmitting unit 37, and the warning mail transmitting unit 38 are realized by the CPU 11, the ROM 12, the RAM 13, the storing unit 14, and the like.

Criteria, based on which the image quality checking unit 35 checks electronic data, will be explained. It is conceivable to check an image quality of electronic data using indexes such as resolution, gradation, brightness, contrast, color balance, chroma, hue, sharpness, density, inclination, and noise. In applying a digital signature to the electronic data and storing the electronic data, for example, the following criteria are set in the electronic document law in Japan. In the case of a color image, gradation equal to or higher than RGB 256 and resolution equal to or higher than 150 dpi (in the case of a tax document, equal to or higher than 200 dpi) are defined. In the case of a monochrome image, monochrome two values and resolution equal to or higher than 150 dpi and monochrome halftone and resolution equal to or higher than 200 dpi are defined. Therefore, in this first embodiment, the criteria are set as criteria of an image quality of electronic data checked by the image quality checking unit 35. In this first embodiment, the criteria for applying a digital signature to electronic data are explained. However, the criteria are not limited to those for applying a digital signature.

The image quality checking unit 35 checks an image quality regardless of the fact that the predetermined criteria are set by the criteria button 16a because of, for example, the following reasons. The user can change a setting of an image quality with the operation unit of the control panel 16. When the user changes the setting in an attempt to create electronic data to realize a better image quality, the user may create electronic data with a setting not conforming to the predetermined criteria by mistake.

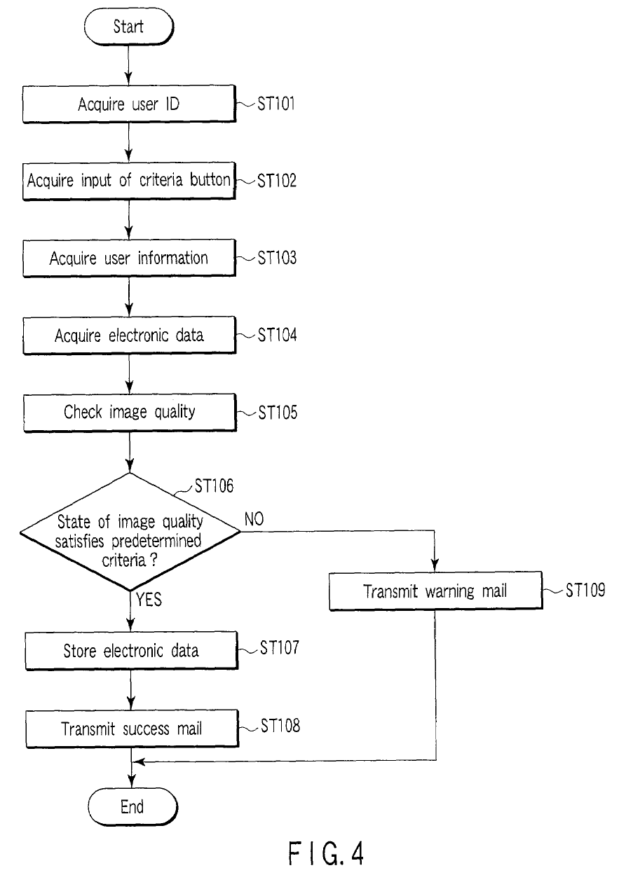

Image quality check processing for checking an image quality of electronic data indicating an image read by the scanner 18 will be explained. FIG. 4 is a flowchart showing a main part of image quality check processing executed by the image forming apparatus 1.

First, a user ID is acquired from the card reader 21 by the user ID acquiring unit 31 (ST101). An input of the criteria button 16a is acquired by the criteria button input acquiring unit 32 (ST102). When an input of the criteria button 16a is not acquired, the following processing is not performed and general processing of the image forming apparatus is performed.

Subsequently, user information is acquired by the user information acquiring unit 33 (ST103). In other words, a mail address corresponding to the user ID acquired in step ST101 is acquired with reference to the user table 14a.

Subsequently, electronic data is acquired by the electronic data acquiring unit 34 (ST104). In other words, electronic data generated by the scanner 18 and stored in the storing unit 14 is subjected to expansion processing by the image processing unit 15 and acquired. This electronic data is temporarily stored in the RAM 13. An image quality of the electronic data temporarily stored in the RAM 13 is checked (ST105). It is judged on the basis of this image quality check whether a state of the image quality of the electronic data satisfies the predetermined criteria (ST106). Steps ST105 and ST106 are executed by the image quality checking unit 35.

When the image quality of the electronic data satisfies the predetermined criteria (YES in ST106), the electronic data is stored by the data storing unit 36 (ST107). In other words, the electronic data temporarily stored in the RAM 13 is stored in a predetermined area in the storing unit 14 as data satisfying the predetermined criteria.

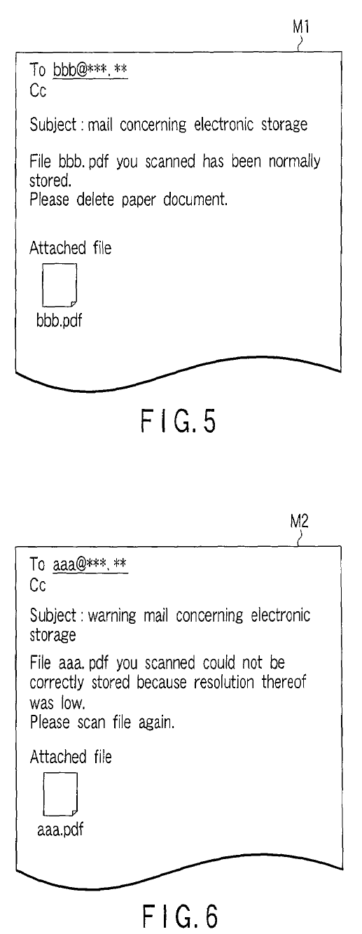

When the electronic data is stored in this way, a success mail is transmitted by the success mail transmitting unit 37 (ST108). In a text of the success mail, it is written that the electronic data satisfying the predetermined criteria is created. The success mail is transmitted to the mail address acquired in step ST103. FIG. 5 is a diagram showing an example of this transmission mail. A description indicating that electronic data (file bbb.pdf) of a scanned paper document is normally stored is included in this success mail M1.

On the other hand, when the image quality of the electronic data does not satisfy the predetermined criteria (NO in ST106), a warning mail is transmitted by the warning mail transmitting unit 38 (ST109). In a text of the warning mail, it is written that electronic data satisfying the predetermined criteria is not created. The warning mail is transmitted to the mail address acquired in step ST103. FIG. 6 is a diagram showing an example of this warning mail. A description indicating that electronic data (aaa.pdf) of a scanned paper document could not be normally stored and a reason for this are included in this warning mail M2.

According to the image forming apparatus 1 in this first embodiment, the user causes the card reader 21 to authenticate the IC card having the user ID stored therein and, then, depresses the criteria button 16a to scan a paper document with the scanner 18. Then, it is judged whether electronic data, which is a scan image of the paper document, satisfies the predetermined criteria. When the electronic data satisfies the predetermined criteria, a success mail is transmitted to a mail address associated with the user ID. When the electronic data does not satisfy the predetermined criteria, a warning mail is transmitted to the mail address.

Therefore, when the user creates electronic data of a paper document, it is possible to automatically check whether the electronic data satisfies the predetermined criteria. When the user creates electronic data of a paper document with the image forming apparatus 1 and comes back to the PC 3 of the user, a success mail or a warning mail is sent to the PC 3. Thus, the user can easily grasp whether the creation of electronic data failed.

### Second Embodiment

A second embodiment will be described. Components identical with those in the first embodiment are denoted by the identical reference numerals and signs and detailed explanations of the components are omitted.

FIG. 7 is a block diagram showing functions of the image forming apparatus 1. The image forming apparatus 1 has a user ID acquiring unit 31, a criteria button input acquiring unit 32, a user information acquiring unit 33, an electronic data acquiring unit 34, an image quality checking unit 35, a data storing unit 36, a success mail transmitting unit 37, a warning mail transmitting unit 38, and a setting editing unit 39. Since the user ID acquiring unit 31, the reference button input acquiring unit 32, the user information acquiring unit 33, the electronic data acquiring unit 34, the image quality checking unit 35, the data storing unit 36, the success mail transmitting unit 37, and the warning mail transmitting unit 38 are the same as those in the first embodiment, explanations of the units are omitted.

The setting editing unit 39 edits, after a warning mail is transmitted to the PC 3 of an operator because an image quality does not satisfy predetermined criteria, a setting in scan operation to eliminate a cause of the low image quality such that it is convenient for the user to scan the paper document again with the scanner 18. In other words, the image forming apparatus 1 stores the transmission of the warning mail in association with a user ID, recognizes the user ID with the card reader 21, and, when there is an input of the criteria button 16a, edits a scan setting to perform scanning with a setting for eliminating a cause of the low image quality. For example, it is assumed that the user changed resolution to a setting of 100 dpi the last time and performed scanning but it was judged that the resolution was low and an image quality was low. In this case, the scan setting is edited to change the resolution to be equal to or higher than 200 dpi (to make it impossible to set resolution to be lower than 200 dpi) such that the predetermined criteria is satisfied this time.

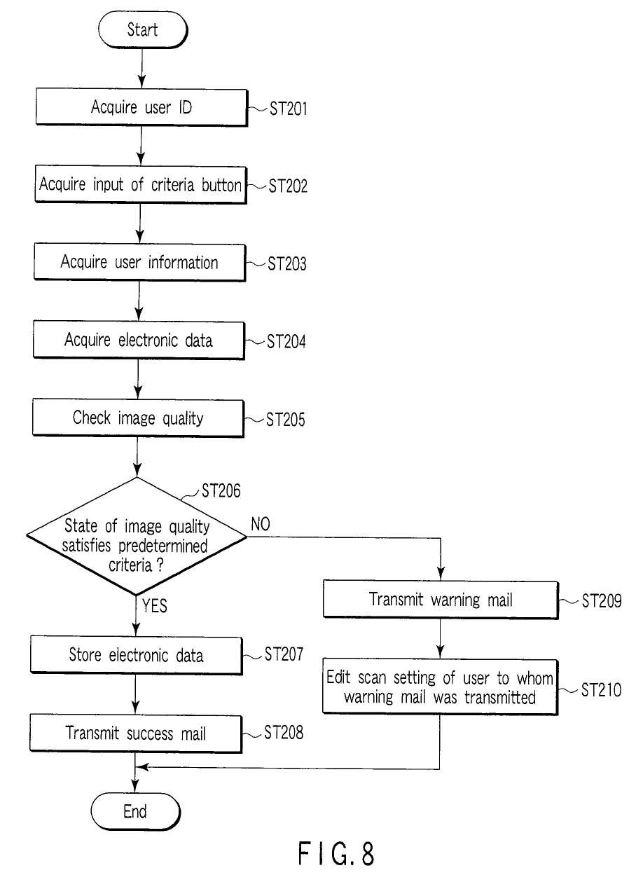

Image quality check processing for checking an image quality of electronic data indicating an image read by the scanner 18 will be explained. FIG. 8 is a flowchart showing a main part of the image quality check processing executed by the image forming apparatus 1.

Since steps ST101 to ST109 of the image quality check processing explained in the first embodiment are the same as steps ST201 to ST209, respectively, explanations of the steps ST201 to ST209 are omitted.

When a warning mail is transmitted by the warning mail transmitting unit 38 (ST209), a setting of the control panel 16 is edited in association with a user ID to which the warning mail is transmitted (ST210). In other words, a scan setting of the scanner 18 of a user ID of a user to whom the warning mail is transmitted is edited to eliminate a cause of the low image quality by the setting editing unit 39.

According to this second embodiment, in addition to the effects of the first embodiment, effects described below are obtained. After a warning mail is transmitted, when a user causes the card reader 21 to recognize a user ID and depresses the criteria button 16a to scan a paper document, a scan setting automatically eliminates a cause of a low image quality. Therefore, operation in reading the paper document again is convenient to the user. It is possible to prevent failure in creation of electronic data.

A setting of the control panel 16 may be freely changed when re-scanning of the user ends.

An indication allowing the user to select criteria of a setting edited in performing re-scanning and initial criteria may be displayed on the display unit of the control panel 16. Consequently, the user can select a setting. This is a convenient effect when there is no problem in a paper document and a scan setting, for example, when a paper document reading surface of the scanner 18 is dirty.

Moreover, in the case in which a warning mail is transmitted because a paper document is read with inclination equal to or larger than a predetermined angle, when the user performs re-scanning, a message “please place a paper document straight and scan the paper document” may be displayed on the control panel 16 when the criteria button 16a is pressed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a user ID acquiring unit configured to acquire a user ID for identifying a user;
a criteria button input acquiring unit configured to acquire an input of a criteria button for instructing creation of electronic data of an image quality satisfying predetermined criteria;
a user information acquiring unit configured to acquire user information indicating a mail address of the user on a network corresponding to the user ID acquired by the user ID acquiring unit;
an electronic data acquiring unit configured to acquire electronic data indicating an image;
an image quality checking unit configured to check, when an input of the criteria button is acquired by the criteria button input acquiring unit, whether an image quality of the electronic data acquired by the electronic data acquiring unit satisfies the predetermined criteria; and
a mail transmitting unit configured to transmit, on the basis of the image quality of the electronic data checked by the image quality checking unit, a mail to a mail address specified by the user information acquired by the user information acquiring unit.

2. An image forming apparatus according to claim 1, wherein the mail transmitting unit transmits, when the image quality of the electronic data satisfies the predetermined criteria as a result of the check by the image quality checking unit, a success mail in which an indication that electronic data indicating the predetermined criteria is created is written to the mail address and transmits, when the image quality of the electronic data does not satisfy the predetermined criteria as a result of the check by the image quality checking unit, a warning mail in which an indication that electronic data indicating the predetermined criteria is not created is written to the mail address.

3. An image forming apparatus according to claim 1, wherein the predetermined criteria are criteria required for applying a digital signature to electronic data.

4. An image forming apparatus according to claim 2, further comprising an editing unit configured to edit, when the warning mail is transmitted to the mail address, predetermined criteria for checking an image quality of electronic data in the image quality checking unit.

5. An image forming apparatus according to claim 4, wherein the editing unit edits the predetermined criteria to eliminate a cause of an image quality lower than predetermined criteria at the time when an image quality of electronic data is checked before transmitting the warning mail.

6. An image forming apparatus according to claim 1, wherein the electronic data acquired by the electronic data acquiring unit is based on image data generated by a scanner.

7. An image forming apparatus according to claim 1, wherein the user ID acquired by the user ID acquiring unit is acquired via a card reader.

8. An image forming apparatus comprising:
user ID acquiring means for acquiring a user ID for identifying a user;
criteria button input acquiring means for acquiring an input of a criteria button for instructing creation of electronic data of an image quality satisfying predetermined criteria;
user information acquiring means for acquiring user information indicating a mail address of the user on a network corresponding to the user ID acquired by the user ID acquiring means;
electronic data acquiring means for acquiring electronic data indicating an image;
image quality checking means for checking, when an input of the criteria button is acquired by the criteria button input acquiring means, whether an image quality of the electronic data acquired by the electronic data acquiring means satisfies the predetermined criteria; and
a mail transmitting means for transmitting, on the basis of the image quality of the electronic data checked by the image quality checking means, a mail to a mail address specified by the user information acquired by the user information acquiring means.

9. An image forming apparatus according to claim 8, wherein the mail transmitting means transmits, when the image quality of the electronic data satisfies the predetermined criteria as a result of the check by the image quality checking means, a success mail in which an indication that electronic data indicating the predetermined criteria is created is written to the mail address and transmits, when an image quality of the electronic data does not satisfy the predetermined criteria as a result of the check by the image quality checking means, a warning mail in which an indication that electronic data indicating the predetermined criteria is not created is written to the mail address.

10. An image forming apparatus according to claim 8, wherein the predetermined criteria are criteria required for applying a digital signature to electronic data.

11. An image forming apparatus according to claim 9, further comprising editing means for editing, when the warning mail is transmitted to the mail address, predetermined criteria for checking an image quality of electronic data in the image quality checking means.

12. An image forming apparatus according to claim 11, wherein the editing means edits the predetermined criteria to eliminate a cause of an image quality lower than predetermined criteria at the time when an image quality of electronic data is checked before transmitting the warning mail.

13. An image forming apparatus according to claim 8, wherein the electronic data acquired by the electronic data acquiring means is based on image data generated by a scanner.

14. An image forming apparatus according to claim 8, wherein the user ID acquired by the user ID acquiring means is acquired via a card reader.

15. A method of checking an image quality of electronic data indicating an image of an image forming apparatus comprising:
acquiring a user ID for identifying a user;
acquiring an input of a criteria button for instructing creation of electronic data of an image quality satisfying predetermined criteria;
acquiring user information indicating a mail address of the user on a network corresponding to the user ID acquired;
acquiring electronic data indicating an image;
checking, when an input of the criteria button is acquired, whether an image quality of the electronic data acquired satisfies the predetermined criteria; and
transmitting, on the basis of the image quality of the electronic data checked, a mail to a mail address specified by the user information acquired.

16. A method according to claim 15, wherein, in transmitting the mail, when an image quality of the electronic data satisfies the predetermined criteria as a result of the check, a success mail in which an indication that electronic data indicating the predetermined criteria is created is written is transmitted to the mail address and, when an image quality of the electronic data does not satisfy the predetermined criteria as a result of the check, a warning mail in which an indication that electronic data indicating the predetermined criteria is not created is written is transmitted to the mail address.

17. A method according to claim 15, wherein the predetermined criteria are criteria required for applying a digital signature to electronic data.

18. A method according to claim 16, further comprising editing, when the warning mail is transmitted to the mail address, predetermined criteria for checking an image quality of the electronic data.

19. A method according to claim 18, wherein, in the editing, the predetermined criteria is edited to eliminate a cause of an image quality lower than predetermined criteria at the time when an image quality of electronic data is checked before transmitting the warning mail.

20. A method according to claim 15, wherein the electronic data acquired is based on image data generated by a scanner.
